(19) United States
(12) Patent Application Publication
(10) Pub. No.: US 2007/0001805 A1
(43) Pub. Date: Jan. 4, 2007

(54) Multiple vehicle authentication for entry and starting systems

(76) Inventors: Thomas E. Utter, Royal Oak, MI (US); David T. Proefke, Madison Heights, MI (US); Robert C. Baillargeon, Utica, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/173,617

(22) Filed: Jul. 1, 2005

(51) Int. Cl. G05B 19/00

(52) U.S. Cl. 340/5.72; 340/5.62

(57) ABSTRACT

Methods and apparatus are provided for one or more electronic keys to be trained to activate multiple vehicles. The apparatus comprises wirelessly communicating electronic key and vehicle authentication modules, each of which comprises inter-coupled processor, non-volatile memory, transmitter and receiver. The module transmitters communicate with the key receiver and vice versa. The key and module exchange ID information during a learning process. These learned IDs are stored in their memories. The key memory stores ID information on a single key and multiple vehicles and the module memory stores ID information on a single vehicle and multiple keys. During authentication, the module and key transmit at least their own IDs to the other. Each compares the received ID to the learned IDs. If they match, authentication is granted and the key command is processed by the vehicle. The number of authenticating keys and vehicles is limited only by onboard memory capacity.

### TECHNICAL FIELD

The present invention generally relates to electronic key and locking systems for vehicle entry, starting and other functions, and more particularly to an apparatus and method whereby individual electronic keys may be authenticated for control of multiple vehicles.

### BACKGROUND

The present invention is described for the case of electronic keys used to authorize vehicle door access, trunk access, and starting, but this is merely for convenience of explanation and not intended to be limiting. Persons of skill in the art will understand based on the description herein that the present invention applies to any electronic key function and not merely to a lock, unlock and start functions and not merely to vehicles. Hence, such other electronic key functions are intended to be included in the words “lock” and “unlock” and “start” and such other locations, equipment, structures and/or apparatus are intended to be included in the word “vehicle.”

Passive keyless access and starting systems facilitate unlocking and unlatching a vehicle's doors, trunks, etc., based on bi-directional communication between the vehicle and the user carried electronic key. Such electronic keys may take the form of credit cards or key fobs. In addition to communicating with the vehicle without direct operator action, they may also include buttons or other activation mechanisms to control vehicle functions upon customer request, for example, door unlock, door lock, engine start, engine stop, temperature control, and so forth, but this is not essential to the present invention.

Conventional prior art electronic keys must generally be “learned” or “trained” to a vehicle prior to use. That is, the control system within the vehicle and the electronic key fob must be programmed with or exchange identifying information so that each party to the bi-directional communication can automatically recognize the other. After the learning or programming process is complete, when the user activates a vehicle function, the electronic key and the vehicle control electronics exchange signals containing identifying and coding information. If the exchanged messages satisfy predetermined criteria, then the requested vehicle function is accepted and carried out. This mutual recognition process between the electronic key and the vehicle control electronics is referred to as “authentication.” Thus, during the learning or training process, information such as, for example, vehicle ID, transmitter ID, encryption key, synchronization count and so forth, that may be desirable to carry out authentication is shared between the vehicle and the electronic key.

While prior art electronic key and locking systems are useful, they suffer from a number of limitations, well known in the art. Among these limitations is the fact that prior art keys can only be learned or programmed to one vehicle at a time. This means, for example, that a person who has several vehicles must carry several keys, one for each vehicle. This is undesirable and often leads to persons taking the wrong key, misplacing currently unused keys, or if carrying them all, having an overstuffed pocket or purse. Thus, a need continues to exist for improved systems and methods that provide a single key that can be learned and used with multiple vehicles so that it is no longer necessary to carry multiple keys.

Accordingly, it is desirable to provide an improved electronic key and vehicle control system and method that make it possible for a single key to activate multiple vehicles. It is further desirable that the system not compromise vehicle security, that is, be at least as secure as an individual key for the same vehicle. In addition, it is desirable that the improved apparatus and method be generally compatible with existing electronic key communication systems so that the invented system and method may be implemented with minimum alteration of existing vehicle control systems. Furthermore, other desirable features and characteristics of the present invention will become apparent from the subsequent detailed description and the appended claims, taken in conjunction with the accompanying drawings and the foregoing technical field and background.

### BRIEF SUMMARY

An apparatus is provided that enables an individual electronic key to be trained for and securely activate multiple vehicles. The apparatus comprises an electronic key, e.g., in the form of a fob, and a vehicle authentication module adapted to wirelessly intercommunicate. The key and module each comprise inter-coupled processor, memory, transmitter and receiver. The transmitter of the module is configured to wirelessly communicate with the receiver of the key and the transmitter of the key is configured to wirelessly communicate with the receiver of the module. The memory of the key and module each comprises non-volatile memory. The key memory is adapted to store unique identification (ID) information concerning a single key and multiple vehicles. The module memory is adapted to store unique identification (ID) information concerning a single vehicle and multiple keys. During authentication, the key compares vehicle identification information received from the module with vehicle information that was stored in its memory during the training phase and the module compares key information received from the key with key information that was stored in its memory during the training phase. If the stored and received information match in one or both, vehicle functions requested in the presence of the key or vehicle commands initiated through the key are enabled.

A method is provided for enabling a particular electronic key to control multiple vehicles. The method comprises key-vehicle training to identify a particular key to multiple vehicles and key-vehicle authenticating to verify that the particular key has been trained for the vehicle being addressed by the key. Training comprises transmitting to and storing in memory in the vehicle information concerning one or more keys and transmitting to and storing in memory in the key information concerning multiple vehicles. Authentication comprises receiving in the vehicle identifying information from a particular key and comparing such information with key identifying information stored in memory in the vehicle and authenticating the key if such information matches in the vehicle. Alternatively, authentication can take place in the key where ID information received from a vehicle is compared to vehicle ID information stored in the key. In a further alternative, authentication occurs mutually in both the key and the vehicle module. Training is repeated for different vehicles using a single key, for different keys using a single vehicle or for a combination thereof. The key can enable passive vehicle functions or directly command functions for any vehicle to which it has been trained.

### BRIEF DESCRIPTION OF THE DRAWINGS

The present invention will hereinafter be described in conjunction with the following drawing figures, wherein like numerals denote like elements, and

FIG. 1 is a simplified schematic block diagram of a system adapted to train and authenticate a single key to multiple vehicles or multiple keys to a single vehicle or a combination thereof;

FIG. 2 is a simplified flow chart illustrating a method, according to the present invention, for training a vehicle to recognize a particular key;

FIG. 3 is a simplified flow chart illustrating a method according to the present invention, for training a key to recognize a particular vehicle;

FIG. 4 is a simplified flow chart illustrating a method according to the present invention for the authenticating a key by the vehicle; and

FIG. 5 is a simplified flow chart illustrating a method according to the present invention for the authenticating a vehicle by a key.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. The words “key” and “fob”, singular or plural, are used interchangeably to represent an electronic key whether in fob-like form or not.

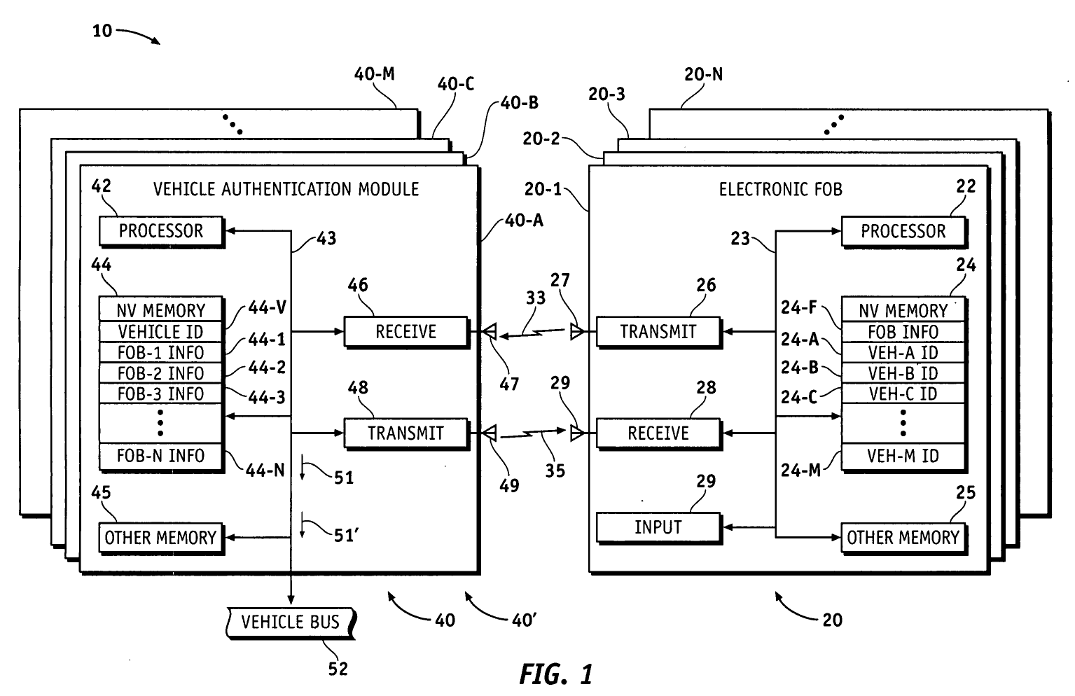

FIG. 1 is a simplified schematic block diagram of system 10 adapted to train and authenticate a single fob to multiple vehicles or multiple fobs to a single vehicle or a combination thereof. System 10 comprises one or more electronic fobs 20 and one or more vehicle training and authentication modules 40 on different vehicles. Fobs 20 may comprise any number of substantially identical fobs 20-1, 20-2, 20-3, . . . 20-N and reference number 20 is intended to refer to such multiple fobs collectively. Fob 20 comprises processor 22, memory 24, 25, transmitter 26 with antenna 27, receiver 28 with antenna 29 and optional user input 29, all conveniently coupled by bus or leads 23. Memory 24 has multiple regions 24-A, 24-B, 24-C . . . 24M for storing information (e.g., unique IDs) for different vehicles VEH-A, VEH-B, VEH-C . . . VEH-M (collectively vehicles 40′).

Different vehicles VEH-A, VEH-B, VEH-C . . . VEH-M each have substantially identical modules 40-A, 40-B, 40-C, . . . 40-M and reference number 40 is intended to refer to such multiple vehicle modules collectively and reference number 40′ to refer to the corresponding vehicles (not shown) containing modules 40. Modules 40 comprises processor 42, memory 44, 45, receiver 46 with antenna 47 and transmitter 48 with antenna 49, all conveniently coupled by bus or leads 43. Signals 33, 35 are exchanged between modules 40 and keys 20.

During training, information about the desired vehicles is sent to and stored in the fobs. For example, antenna 29 and receiver 28 receive signal 35 from antenna 49 and transmitter 48 of, for example, vehicle module 40A of vehicle 40′-A (not shown) containing module 40-A. Signal 35 contains at least a unique identifier (e.g., VEH-A ID) for first vehicle module 40A of vehicle 40′-A. The unique identifier is transferred via bus or leads 23 to memory 24 where it is stored in an available vehicle ID memory region, e.g., memory region 24-A. In this way, fob 20-1 learns the unique ID (e.g., VEH-A ID) of first vehicle authentication module 40-A and thus of first vehicle 40′-A. Memory 24 also has ID information (e.g., FOB INFO) on the particular fob, e.g., ID information on fob 20-1, conveniently stored in region 24-F of memory 24. Fob 20 may be trained with other vehicles and memory regions 24-B, 24-C . . . 24-M populated with unique identifiers VEH-B ID, VEH-C ID . . . VEH-M ID. In this way unique IDs on all of the vehicles that fob 20-1 is desired to be able to activate or control are stored in memory in fob 20-1. The same process may be repeated for the same or different combinations of vehicles for other fobs 20-2, 20-3 . . . 20-N. This any number of fobs can be trained to any number of vehicles up to the limits of memory 24.

During training, information about the desired fobs is sent to and stored in the vehicles. For example, antenna 47 and receiver 46 receives signal 33 from antenna 27 and transmitter 26 of, for example, fob 20-1, such signal containing at least a unique identifier (e.g., FOB-1 INFO) for first fob 20-1. The unique identifier is transferred via bus or leads 43 to memory 44 where it is stored in an available vehicle ID memory region, e.g., memory region 44-1. In this way, vehicle module 40-A learns the identity of first fob 20-1. Memory 44 also has vehicle ID information (e.g., VEH-ID) on the particular vehicle module, e.g., ID information on module 40-A, conveniently stored in region 44-F of memory 44. By exchanging training signals 33, 35 with different fobs 20-1, 20-2, 20-3 . . . 20-M, memory regions 44-1, 44-2, 44-3 . . . 44-N of vehicle module 40-A are populated with unique fob identifiers, e.g., FOB-1 INFO, FOB-2 INFO, FOB-3, INFO . . . FOB-N INFO. In this way, the unique IDs of all of the fobs that module 40-A needs to authenticate are stored in memory 44 of module 40-A. The same process may be repeated for the same or different combinations of fobs for other vehicles 40-A, 40-B, 40-C . . . 40-M. Thus, any number of fobs 20-1, 20-2 20-3, . . . 20-N can be trained to any number of vehicles 40-A, 40-B, 40-C . . . 40-M up to the limits of memory 44. Once training is complete, authentication can be performed.

During authentication, signal 35 contains the unique ID of the particular vehicle 40 being accessed and preferably a randomly or pseudo-randomly generated challenge is also sent. Processor 42 uses the information from signal 35, in concert with an encryption or other authentication algorithm and the fob information stored in memory 44, to generate expected responses from fobs 20 programmed to the vehicle. During authentication, a fob present in the vicinity of vehicle 40 receives signal 35 via receiver 28 and compares the received vehicle ID with those stored in memory 24. If the received vehicle ID matches one of the values stored as programmed vehicle IDs, processor 22 can conveniently calculate, using the vehicle ID, the fob ID stored in memory 24-F, and the same encryption or other authentication algorithm used by the vehicle, to generate a response value. This response value is then sent as signal 33 to the vehicle. Upon receipt of signal 33 from the fob, vehicle processor 42 will compare the received response to the expected responses it has calculated. If the responses match, the requested vehicle function or functions are enabled, for example by sending signal 51 to vehicle bus 52. With this arrangement, authentication occurs in both the vehicle and the fob, and the authentication can occur without director operator interaction with the fob.

For vehicle commands being initiated through the fob, authentication within the vehicle facilitates faster response time without sacrificing the desired level of security. In such cases, activation of fob input 29 can cause processor 22 to generate signal 33, desirably comprised of command information, fob ID information, and synchronization information all encrypted as is common in the art. Upon receipt of signal 33 by vehicle 40, processor 42 will use available fob IDs from memory 44 to decrypt signal 33. If the decrypted information comprises a valid command from a valid fob with a valid synchronization value, the vehicle will initiate execution of the received command. Thus, authentication can take place either in fob 20 or in module 40 or partly in each. What is important is that the combination of fob 20 and vehicle module 40 authenticate by comparing query signals received from the other with IDs or other unique tags stored in their internal memory, and accept the command or query if a match is found and reject the command or query if a match is not found. It is important that one or both of fob 20 and vehicle module 40 have memory, preferably non-volatile (NV) memory where unique identifiers of multiple allowed vehicle-fob combinations can be stored during learning or training for use during authentication. After training, a single fob can control multiple vehicles or a single vehicle can respond to multiple fobs, and if trained with multiple vehicles, multiple fobs can control multiple vehicles. This provides the user with complete flexibility.

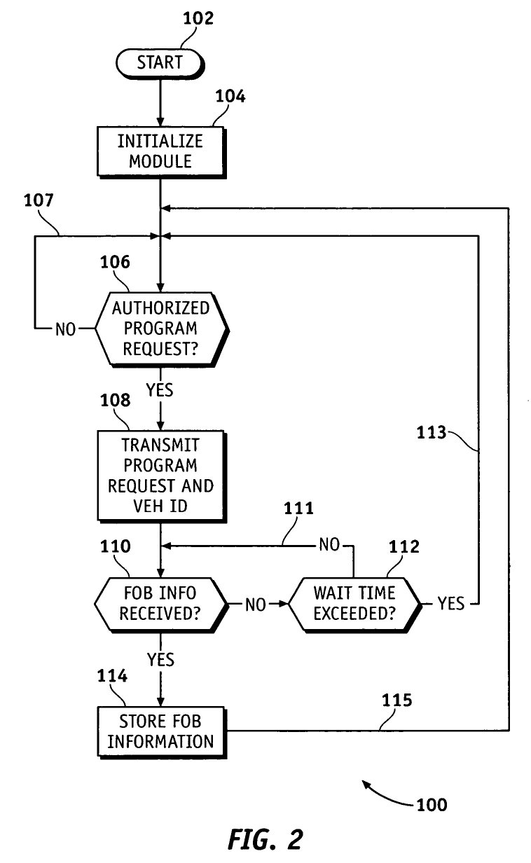

FIG. 2 is a simplified flow chart illustrating method 100 according to the present invention, for training a vehicle 40′ to recognize a particular key fob 20. Method 100 begins at START 102, which desirably occurs when vehicle activity prompts vehicle module 40 to wake up from a sleep state. In step 104, module 40 is initialized, that is, brought from its quiescent state to its active state. Initialization step 104 is follows by AUTHORIZED PROGRAM REQUEST ? query 106 wherein it is determined whether an authorized program request has been received by module 40 from a vehicle operator, for example by password receipt form vehicle bus 52 as sent from a specialized service tool. If the outcome of query 106 is NO (FALSE) then method 100 loops back as shown by path 107. Thus, until a valid program request is received, method 100 stays in loop 106-107. When the outcome of query 106 is YES (TRUE), method 100 advances to step 108 wherein the program request and vehicle ID are sent via signal 35 from transmitter 48 and antenna 49 to antenna 29 and receiver 28 of fob 20. Fob processor 22 obtains the vehicle ID information from receiver 28 and conveniently stores it in memory 24, for example, in memory portion 24-A. Memory portion 24-F already contains the fob information. Method 100 then advances to FOB INFO RECEIVED ? query 110 wherein it is determined whether or not fob 20 has responded to transmitting step 108 and sent its fob ID information back to module 40. If the outcome of query 110 is NO (FALSE) then method 100 advances to optional WAIT TIME EXCEEDED ? query 112, wherein it is determined whether or not the elapsed time since transmit step 108 exceeds a predetermined wait time. Persons of skill in the art will know how to determine an appropriate wait time for their particular system. If the outcome of query 112 is NO (FALSE), then method 100 loops back to query 110 as shown by path 111. Method 100 will remain in loop 110, 112, 111 until the outcome of either of queries 110 or 112 is YES (TRUE). If the outcome of query 112 is YES (TRUE) indicating that the allowed wait time is exceed, method 100 loops back to initial query 106 as shown by path 113. If the outcome of query 110 is YES (TRUE), then method 100 advances to STORE FOB INFORMATION step 114, wherein the FOB INFO from portion 24F of memory 24 of fob 20 is stored in, for example, portion 44-1 of memory 44 of module 40. Following step 114, method 100 loops back to initial query 106 as shown by path 115. Module 40 has received and stored the fob ID and vehicle learning is complete as far as training this vehicle to respond to this fob is concerned. Persons of skill in the art will appreciate based on the description herein, that other types of information useful for the bi-directional secure communication between fob and vehicle or vehicle and fob and can be included in signal 33. Non-limiting examples of such other information are encryption keys, code synchronization counts, transmitter IDs, and so forth. This allows the bi-directional communication to be encrypted and therefore much more immune to spoofing or unauthorized tampering. Such encryption techniques are well known in the art.

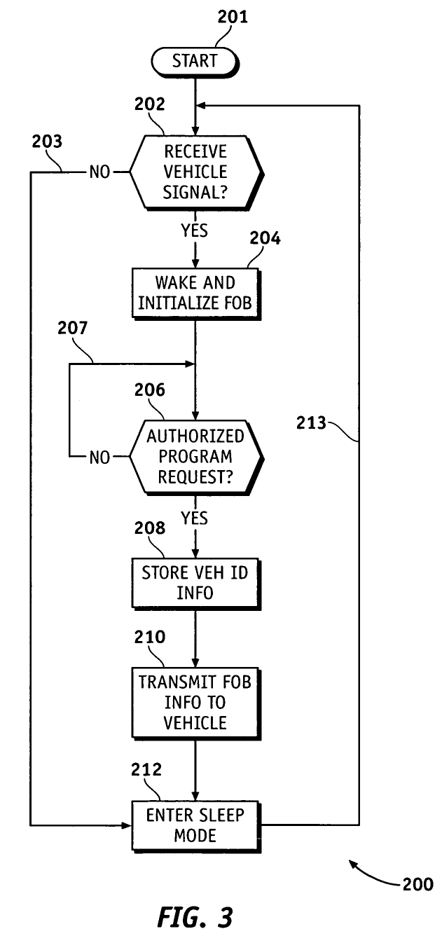

FIG. 3 is a simplified flow chart illustrating method 200 according to the present invention, for training a key fob to recognize a particular vehicle. Method 200 for the fob and method 100 for the vehicle module are intended to be read together, since each describes half of the learning process; method 100 primarily for what is occurring in the vehicle and method 200 primarily for what is occurring in the fob. Method 200 begins with START 201, which generally occurs when power is applied to the fob electronics illustrated in FIG. 1. Ordinarily, fob 20 is in a sleep state wherein only a small portion of its electronics are operating in a power conserving mode, but sufficient to recognize the arrival of signal 35 from module 40. When signal 35 is received by fob 20 and detected in RECEIVE VEHICLE SIGNAL ? query 202, WAKE AND INITIALIZE FOB step 204 is executed, wherein fob 20 is powered up and set to its initial state. Method 100 then advances to AUTHORIZED PROGRAM REQUEST ? query 206 wherein it is determined whether or not signal 35 is an allowed command or query. If the outcome of query 206 is NO (FALSE) then method 100 loops back as shown by path 207. An optional time out step (not shown) similar to query 112 of method 100 may be included in the loop back so as to place fob 20 back in a sleep state if a valid program request is not received within a predetermined time. If the outcome of query 206 is YES (TRUE), then method 200 advances to STORE VEH INFO step 208 wherein at least the vehicle ID (and optionally other information) is written into memory 24, as for example in memory portion 24-1. Following store step 208, method 200 advances to step 210 where the FOB INFO is transmitted to module 40 of vehicle 40′. As shown in step 114 of method 100, this FOB INFO is stored in memory 44, e.g., in portion 44-1 assuming no other fob's information has already been stored in portion 44-1. If valid FOB INFO occupies portion 44-1, then the arriving FOB INFO is conveniently but not essentially stored in the next available memory portion. It can be stored any where in module 40. When step 210 is accomplished, method 200 advances to ENTER SLEEP MODE step 212, wherein fob 20 is powered down as shown by path 213 into a quiescent state, awaiting the arrival of another vehicle signal 35 from the same or a different vehicle 40′. Learning by fob 20 is complete for this vehicle. By reading methods 100, 200 together, it can be seen that mutual learning has been accomplished wherein fob 20 has stored an ID for an authorized vehicle and module 40 of vehicle 40′ has stored an ID for an authorized fob. Methods 100, 200 may be repeated as often as needed to have one or more fobs learn one or more vehicles, depending upon the needs of the user. The only limits on the number of vehicles that a fob can learn and the number of fobs that a vehicle can learn are the sizes of memories 24, 44.

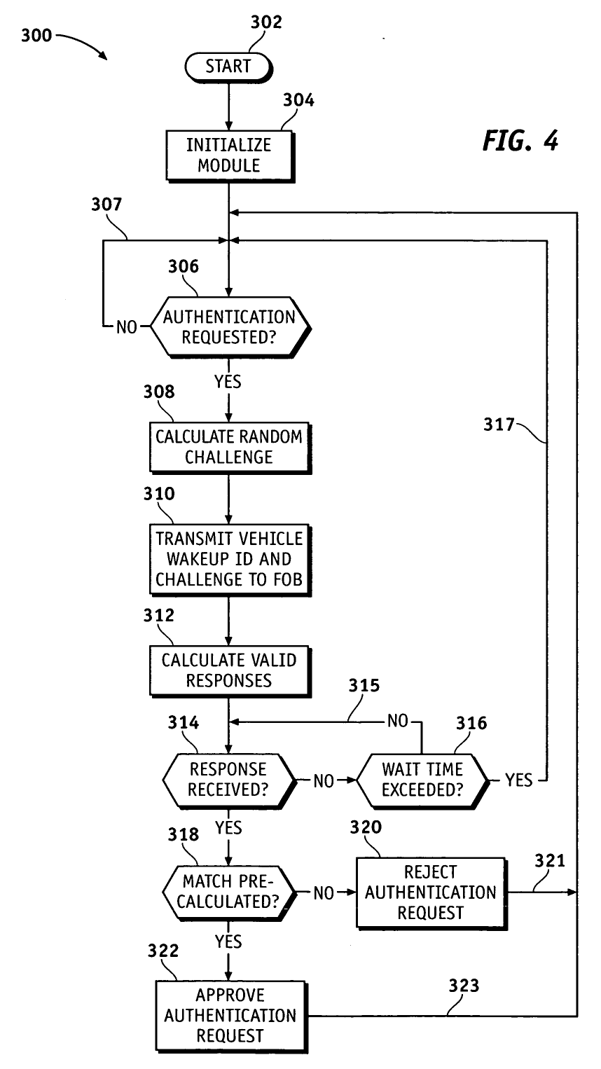

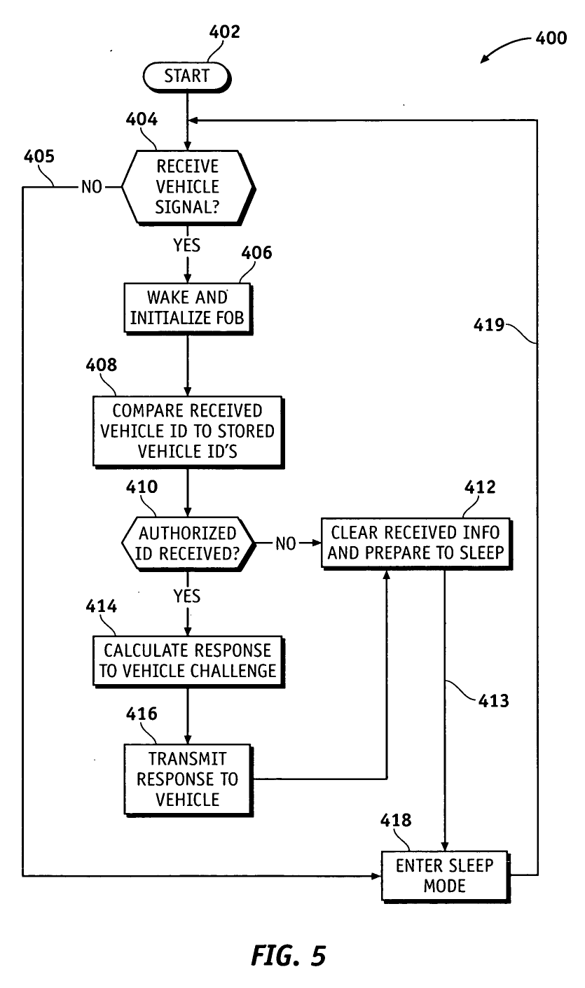

Just as FIGS. 2-3 are intended to be read together to carry out learning or training of the fob-vehicle combination, FIGS. 4-5 are intended to be read together to carry out authentication after learning has been completed. FIG. 4 is a simplified flow chart illustrating method 300 according to the present invention for authenticating a fob by a vehicle (e.g., what happens in the vehicle), and FIG. 5 is a simplified flow chart illustrating method 400 according to the present invention for the authenticating a vehicle by a fob (e.g., what happens in the fob). Referring now to FIG. 4, method 300 begins with START 302 and INITIALIZE MODULE step 304, where module 40 is brought from a quiescent state to an active state. This generally occurs when power is applied to the vehicle module or when the module awakens from a sleep state. Initial AUTHENTICATION REQUESTED ? query 306 is then executed to determine whether a vehicle control or operation has been activated which would require authentication of any electronic keys present, for example, a request to unlock vehicle doors or to start the vehicle engine. Authentication requests may be received from vehicle bus 52 via bus or leads 43 to processor 42. Alternatively, authentication requests may be received from inputs directly connected to vehicle module 40. If the outcome of query 306 is NO (FALSE), them method 300 loops back as shown by path 307. Method 300 will stay in loop 306, 307 until a YES (TRUE) outcome is obtained from query 306. Then CALCULATE RANDOM CHALLENGE step 308 is desirably executed wherein an algorithm stored in memory 44, 45 is executed by processor 42 to provide a preferably random or pseudo-random challenge signal to be sent in TRANSMIT VEHICLE WAKE-UP ID AND CHALLENGE TO FOB step 310 via signal path 35 from module 40 to fob 20. Steps 310 and 312 may be executed in either order. In CALCULATE VALID RESPONSES step 312, processor 42 calculates what response(s) should be received from a valid fob, based on knowledge, for example, of the challenge generated in step 308 and the response algorithm built into or sent to fob 20. Persons of skill in the art will understand based on the description herein how to generate a suitable challenge and response for their particular vehicle-fob combination. It is desirable that the challenge varies in a random or pseudo-random way to guard against spoofing.

In subsequent RESPONSE RECEIVED ? query 314 it is determined whether or not response signal 33 was received from fob 20. If the outcome of query 314 is NO (FALSE), then method 300 proceeds to WAIT TIME EXCEEDED ? query 316. If the outcome of query 316 is NO (FALSE), then method 300 loops back as shown by path 315. Method 300 will remain in loop 314, 316, 315 until a YES (TRUE) outcome is obtained from either of queries 314 or 316. If the outcome of query 316 is YES (TRUE) then method 300 loops back to initial query 306 as shown by path 317. If the outcome of query 314 is YES (TRUE), then method 300 advances to MATCH PRE-CALCULATED ? query 318 wherein it is determined whether the response received from fob 20 matches the pre-calculated response determined in step 312. If the outcome of query 318 is NO (FALSE), meaning that the fob did not return the right answer, then method 300 proceeds to step 320 wherein the authentication request is rejected and, as shown by paths 321, 323 method 300 again loops back to initial query 306. If the outcome of query 318 is YES (TRUE), meaning that the fob did return the right answer, then method 300 advances to APPROVE AUTHENTICATION REQUEST step 322 wherein the authentication request is granted and whatever command is associated therewith is approved for execution by, for example, having processor 42 transmit appropriate signal 51, 51′ to vehicle bus 52. Following authentication approval step 322, method 300 loops back to initial query 306 as shown by path 323 and awaits a further authentication request.

As noted earlier, FIG. 5 is a simplified flow chart illustrating companion method 400 according to the present invention for the authenticating a vehicle by a fob (e.g., primarily what happens in the fob). Method 400 is carried out in fob 20 in concert with method 300 being carried out in vehicle module 40. Method 400 begins with START 402 that desirably occurs when power is provided to fob 20. Fob 20 is conveniently but not essentially in a sleep mode wherein most of the electronics in fob 20 are quiescent and just enough are powered to detect an incoming signal. Initial RECEIVE VEHICLE SIGNAL ? query 404 is executed wherein it is determined whether fob 20 has received signal 35 from vehicle module 40. This is, for example, the signal that is transmitted in step 310 of method 300. If the outcome of query 404 is NO (FALSE) then as shown by path 405, fob 20 returns to ENTER SLEEP MODE step 418. If the outcome of query 404 is YES (TRUE), then WAKE AND INITIALIZE FOB step 406 is executed, wherein fob 20 is returned to a fully active state and initialized. Method 400 then advances to step 408 wherein the received vehicle ID is compared to the vehicle IDs that were stored in memory 24, e.g., in portions 24-1, 24-2 . . . and so forth, during learning. Method 400 then advances to AUTHORIZED ID RECEIVED ? query 410 wherein it is determined whether or not the vehicle ID received in step 404 matches a learned vehicle ID. If the outcome of query 410 is NO (FALSE), meaning that the received ID did not match any stored in memory 24, then in step 412 the received information is cleared and fob 20 is readied to be placed back in sleep mode via path 413 and ENTER SLEEP MODE step 418. If the outcome of query 410 is YES (TRUE), meaning that the received vehicle ID matches a vehicle ID stored in memory 24, then method 400 advances to CALCULATE RESPONSE TO VEHICLE CHALLENGE step 414 wherein processor 22, for example, operates on the challenge in a predetermined way to produce a response that is predictable when, for example, vehicle ID, fob ID, challenge information, and authentication algorithm are known. In step 416, the response is transmitted via signal 33 back to module 40 and method 400 advances to clear and prepare step 412 and ENTER SLEEP MODE step 418. The response sent in step 416 of method 400 is the response received, for example, in connection with query step 314 of method 300. After returning to sleep mode in step 418, method 400 awaits receipt of another vehicle signal in step 404, as shown by path 419.

While at least one exemplary embodiment has been presented in the foregoing detailed description, it should be appreciated that a vast number of variations exist. For example, while the foregoing describes exchange of unique IDs from various vehicles to one or more fobs and from one or more fobs to various vehicles, persons of skill in the art will understand based on the description herein that the unique IDs may take many forms and may be encrypted and/or encoded prior to transmission and/or prior to storage. Thus, IDs may be transmitted and/or stored in plain or manipulated form and therefore, as used herein, the words “unique identifier”, the abbreviation “ID” and the phrases “unique ID”, “ID information” and equivalents, whether plural or singular, are intended to include such manipulated forms and manipulations thereof and other variations. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An electronic key for authenticating and activating each of a plurality of vehicles, the electronic key comprising:
a memory having a first portion configured to retain a unique ID for the electronic key and a second portion adapted to store information uniquely associated with each of the plurality of vehicles; and
a processor in communication with the memory configured to wirelessly obtain a vehicle ID associated with each of the plurality of vehicles and to thereby control operations in at least one of the plurality vehicles if the received vehicle ID for that vehicle matches the information stored in the second portion of the memory.

2. The electronic key of claim 1 wherein the processor is configured to operate in a training phase wherein the unique ID is transmitted to each of the plurality of vehicles and wherein the vehicle IDs associated with each of the plurality of vehicles are stored in the second portion of the memory.

3. The electronic key of claim 1 wherein the processor is further configured to transmit the unique ID to each of the plurality of vehicles.

4. The apparatus of claim 1 wherein the electronic key further comprises a first input in communication with the processor and adapted for use by an operator of the electronic key.

5. A system for allowing one or more electronic keys to activate multiple individual vehicles, the system comprising:
at least one wirelessly communicating electronic key comprising a key processor, a key transceiver and a key memory is configured to store a key ID; and
a plurality of authentication modules, each associated with one of the multiple individual vehicles and comprising a module processor, a module transceiver and a module memory configured to store a module ID, wherein the processors of each of the authentication modules and the at least one electronic key are configured to wireless communicate via the transceivers to exchange ID information stored in the key and module memories, to authenticate based at least in part upon matches between the ID information, and to permit the at least one electronic key to activate each the multiple individual vehicles associated with the authentication modules for which such matches are obtained.

6. The system of claim 5 wherein each of the authentication modules and the at least one electronic key are further configured to communicate with each other to exchange ID information during a learning mode.

7. The system of claim 5 wherein each authentication module further comprises an input-output coupled between a vehicle bus and the processor of the module.

8. A method for enabling an electronic key having a unique key ID to control operations in multiple vehicles, each having a unique vehicle ID, comprising:
during a learning phase, sending unique vehicle IDs to the key for storage in key memory and sending the unique key ID to the multiple vehicles for storage in vehicle memory in each of the multiple vehicles; and
during an authentication phase, sending a unique vehicle ID from the vehicle desired to be controlled by the key to the key and sending the unique key ID to the vehicle desired to be controlled by the key; and
comparing in the key the one unique vehicle ID received during the authentication phase with the multiple unique vehicle IDs received during the training phase; and
comparing in the vehicle the unique key ID received during the authentication phase with the unique key ID received during the training phase; and
if the results of both comparing steps provide a match, authenticating the key to the vehicle desired to be controlled by the key; and
if the results of either comparing step fails to provide a match, not authenticating the key.

9. The method of claim 8 wherein the comparing steps comprise:
only comparing in the key the one unique vehicle ID received during the authentication phase with the multiple unique vehicle IDs received during the training phase and not comparing in the vehicle; and
if the results of the only comparing step provide a match, authenticating the key to the vehicle desired to be controlled by the key; and
if the results of the only comparing step fails to provide a match, not authenticating the key.

10. The method of claim 8 wherein the comparing steps comprise:
only comparing in the vehicle the unique key ID received during the authentication phase with the unique key ID received during the training phase; and
if the results of the only comparing step provide a match, authenticating the key to the vehicle desired to be controlled by the key; and
if the results of the only comparing step fails to provide a match, not authenticating the key.

11. The method of claim 8 wherein the second sending step comprises:
calculating a challenge to be addressed to the electronic key;
then in either order sending the challenge from the vehicle to the key and predicting a valid response from the electronic key;
receiving in the vehicle from the electronic key a response to the challenge; and
comparing the received response to the predicted response; and
authenticating the key to the vehicle only if the received challenge response matches the predicted challenge response.

12. The method of claim 11 wherein the second sending step further comprises:
receiving in the key the challenge calculated in the vehicle; and
calculating a response to the challenge received from the vehicle; and
sending the challenge response to the vehicle.

13. A method for enabling a particular electronic key to control functions of multiple vehicles, comprising:
key-vehicle training to identify a particular key to multiple vehicles by transmitting to and storing in memory in each vehicle information concerning one or more keys; and
key-vehicle authenticating to verify that the particular key has been trained for the vehicle being addressed by the key, by receiving in the vehicle identifying information from a particular key and comparing such information with key identifying information stored in memory in the vehicle during training and enabling the key to control functions of the vehicle if such information matches.

14. The method of claim 13 further comprising:
during key-vehicle training, transmitting to and storing in memory in the key information concerning the multiple vehicles; and
during key-vehicle authenticating receiving in the vehicle identifying information from a particular key and comparing such information with key identifying information stored in memory in the vehicle during training and receiving in the key identifying information from a particular vehicle and comparing such information with vehicle identifying information stored in memory in the key during training, and enabling the key to control functions of the vehicle only if such information matches in both the vehicle and the key.

15. A method for enabling a particular electronic key to control functions of multiple vehicles, comprising:
key-vehicle training to identify a particular key to multiple vehicles by transmitting to and storing in memory in the key information concerning the multiple vehicles; and
key-vehicle authenticating to verify that the particular key has been trained for the vehicle being addressed by the key by receiving in the key identifying information from a particular vehicle and comparing such information with multiple vehicle identifying information stored in memory in the key during training and enabling the key to control functions of the vehicle if such information from the particular vehicle matches stored information of at least one vehicle.

16. The method of claim 15 further comprising:
during key-vehicle training, transmitting to and storing in memory in the vehicle information concerning the one or more keys; and
during key-vehicle authenticating receiving in the vehicle identifying information from a particular key and comparing such information with key identifying information stored in memory in the vehicle during training and receiving in the key identifying information from a particular vehicle and comparing such information with vehicle identifying information stored in memory in the key during training, and enabling the key to control functions of the vehicle only if such information matches in both the vehicle and the key.

17. A method for enabling a particular electronic key to control functions of multiple vehicles, comprising:
key-vehicle training to identify a particular key to multiple vehicles by transmitting to and storing in memory in each vehicle information concerning one or more keys and transmitting to and storing in memory in the key information concerning the multiple vehicles; and
key-vehicle authenticating to verify that the particular key has been trained for the vehicle being addressed by the key by;
receiving in the vehicle identifying information from a particular key and comparing such information with key identifying information stored in memory in the vehicle during training; and
receiving in the key identifying information from a particular vehicle and comparing such information with vehicle identifying information stored in memory in the key during training; and
enabling the key to control functions of the vehicle if the information in both receiving steps provide matches.

18. The method of claim 17 further comprising:
prior to the second receiving step, providing in the vehicle a challenge to be issued by the vehicle to the key; and then in either order, sending the challenge to the key and determining a predicted response that the key should provide based on the challenge
prior to the first receiving step, receiving the challenge in the key, generating a response to the challenge and sending the response back to the vehicle; and
during the enabling step, enabling the key control functions only if the response received from the key matches the predicted response.

19. The method of claim 18 wherein the challenge is random or pseudo-random.
